(19) United States
(12) Patent Application Publication
(10) Pub. No.: US 2015/0254936 A1
(43) Pub. Date: Sep. 10, 2015

(54) Systems and Methods for Online over the Shoulder Betting

(71) Applicant: Gregory STUPPLER, West Bloomfield, MI (US)

(72) Inventor: Gregory Stuppler, Singapore (SG)

(21) Appl. No.: 14/432,205

(22) PCT Filed: Oct. 2, 2013
(86) PCT No.: PCT/US13/62944

§ 371 Date: Mar. 28, 2015

Related U.S. Application Data
(60) Provisional application No. 61/708,682, filed on Oct. 2, 2012.

(51) Int. Cl. G07F 17/32; G06Q 50/34

(52) U.S. Cl. CPC G07F 17/3288; G06Q 50/34; G07F 17/3225; G07F 17/3293

(57) ABSTRACT

Systems and methods are provided for enabling online users to place bets on a participant in a gambling activity using a network. Video and/or data are sent in real time to one or more user devices of one or more online users using a processor and a network. The video shows one or more participants in a gambling activity. A betting interface that receives at least one message from the one or more user devices is provided using the processor and the network. The at least one message represents a bet placed on at least one participant of the one or more participants by at least one online user of the one or more online users.

### CROSS-REFERENCE TO RELATED APPLICATION

This application claims the benefit of U.S. Provisional Patent Application No. 61/708,682 filed Oct. 2, 2012, the content of which is incorporated by reference herein in its entirety.

### INTRODUCTION

Over the shoulder (“OTS”) betting is a gambling activity common with gamblers in casinos in Macau and Singapore, for example. In OTS betting, gamblers reach over the shoulder of seated gamblers to make passive wagers on the seated players' hands or bet on other players' hands. Some bet over the shoulder because there are no seats, others prefer to bet on the luck of others rather than the game itself, and others like betting on derivative wagers which are inherently possible, or explicitly created, within the game (e.g., insurance against a dealer blackjack, the odds of snake-eyes at craps, etc.). OTS gamblers may, or may not, influence the gamblers who occupy the casino table seat. However, the decisions at the table are ultimately made by the person who occupies the seat. Essentially, OTS is betting on the bets of others and by its nature expands the number of wagers which can occur of a fixed number of casino table-seats. OTS also has the power to expand the social nature of game.

Online gambling or Internet gambling is a gambling activity that has been around since, at least, the vast expansion of the Internet in the 1990s. Online gambling can involve playing games with and betting against other players virtually over a network connection. Alternatively or in addition, online gambling can include playing games with and betting against the house or a casino virtually over a network connection. Currently, however, there are no online gambling systems that allow for online OTS betting on participants in a gambling activity in a real casino or participants in an online gambling activity.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a schematic diagram of a system for providing online over the shoulder (OTS) betting, including enabling online users to place bets on a participant in a gambling activity using a network, in accordance with various embodiments.

FIG. 3 is a flowchart showing a method for enabling online users to place bets on a participant in a gambling activity using a network, in accordance with various embodiments.

FIG. 4 is a schematic diagram of a system that includes one or more distinct software modules that performs a method for enabling online users to place bets on a participant in a gambling activity using a network, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

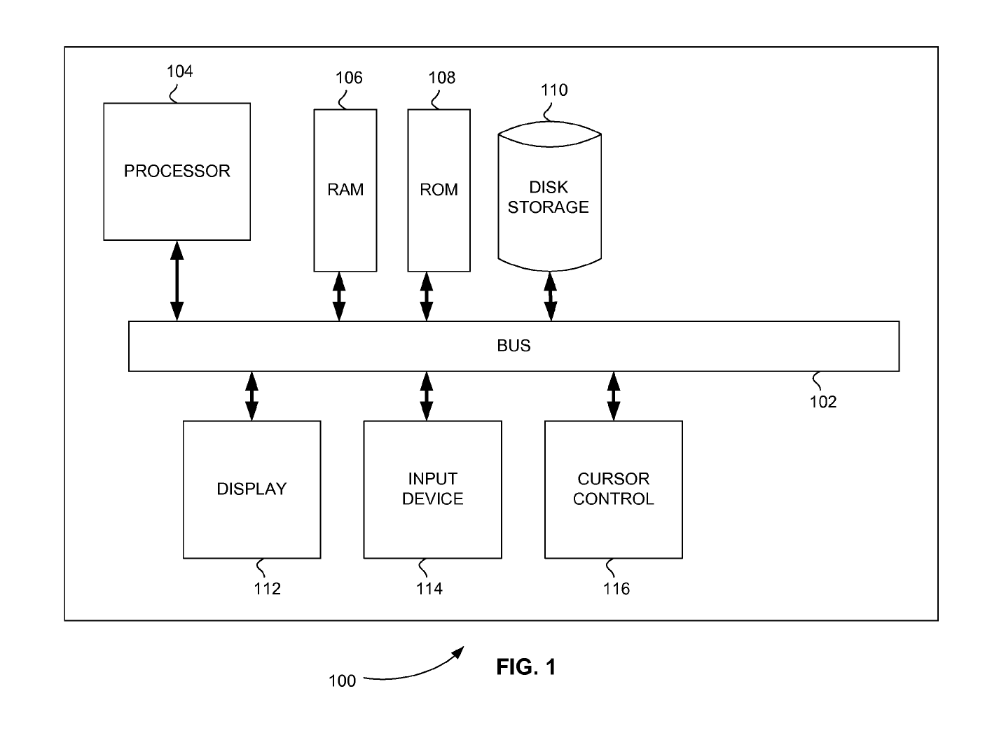

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102, as well as wireless technologies, such as optical light transmission.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read. One skilled in the art will appreciate that other types of storage technologies, including those developed in the future, may equally be used.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Methods for Online Over the Shoulder Betting

As described above, over the shoulder (“OTS”) betting is a gambling activity where gamblers virtually reach over the shoulder of seated gamblers to make passive wagers on the seated players' hands, and/or derivative wagers empowered by the seated gambler's position at the table. Player's bets can be with, or against, another player, or they could be with, or against the house, depending on the game rules of that particular game. Online gambling or Internet gambling is a gambling activity where gamblers can play games with and bet against other players or the house virtually over a network connection. Currently, however, there are no online gambling systems that allow for online OTS betting on participants in a gambling activity in a real casino or participants in an online gambling activity.

In various embodiments, systems and methods are provided that allow online users to place bets on participants in a gambling activity. The gambling activity can include, but is not limited to, a gambling activity taking place with the gambler's physical presence at a real casino (or a real gambling environment that includes less regulated venues, such as ad hoc card games, sporting events, and the like) or a virtual gambling activity taking place between online participants or with a virtual casino. Gambling activity can include, but is not limited to, betting on card games, table games, sporting events, or any game of chance. The participants can include, but are not limited to, onsite gamblers or the house at a real casino, an onsite gambler at a real casino taking direction from an online user, or virtual gamblers or the virtual house in a virtual casino.

In various embodiments, systems and methods provide the online users with one or more real-time or substantially real-time video and/or data feeds of the participants in the gambling activity. The one or more video and/or data feeds provide the online users with information about the gambling activity and ensure the online (or television) users that the gambling activity is taking place in real time.

In various embodiments, systems and methods provide the online users with one or more additional real-time or substantially real-time video and/or data feeds. These one or more additional video and/or data feeds can include, but are not limited to, video of cards, chips, gambling tables, displays of sports scores, displays of odds of a gaming activity, or displays of screens of participants in an online gambling activity. In addition, the one or more additional video feeds can include video of the online users displayed with a participant of the gambling activity, for example. Video of the online users displayed with a participant of the gambling activity and rebroadcast to the online user can verify that the gaming activity is taking place in real-time.

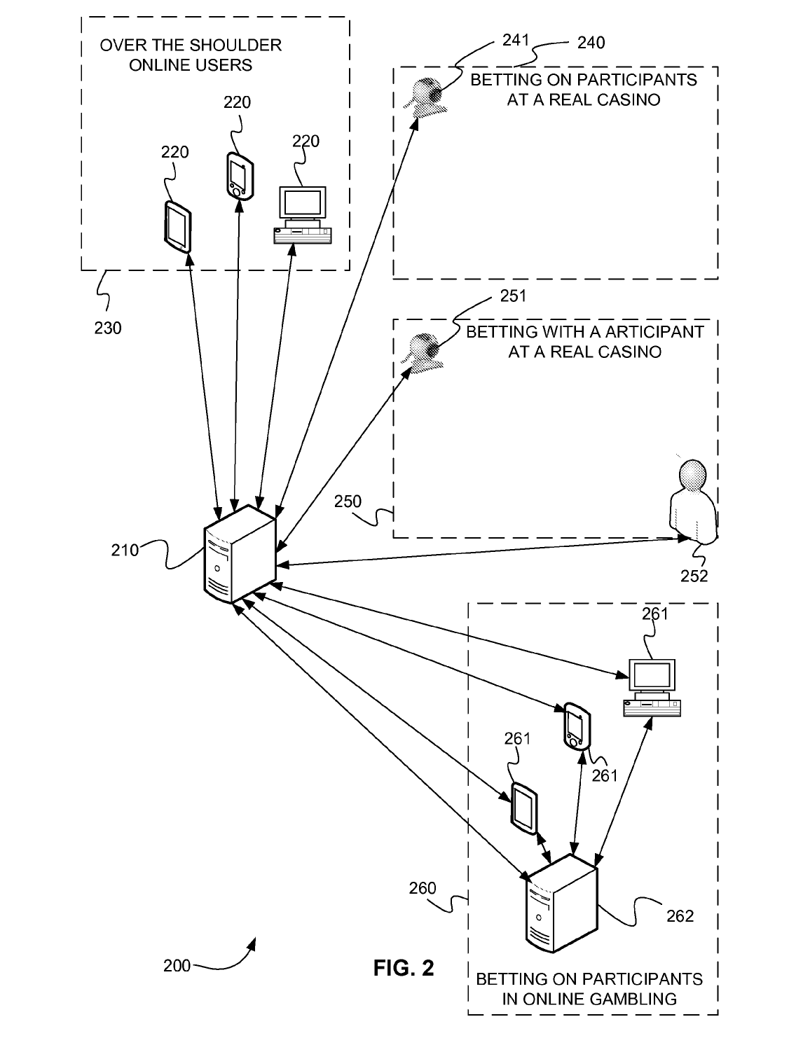

FIG. 2 is a schematic diagram of a system 200 for providing online OTS betting, in accordance with various embodiments. System 200 includes server 210. Server 210 can be, but is not limited to, a server computer, a virtual machine running on a group or cloud of server computers, or a group or cloud of virtual machines or sever computers.

Server 210 sends video and/or data in real time, or substantially real-time, to one or more user devices 220 using a network. User devices 220 include, but are not limited to smartphones, game players, music players, tablets, laptops, wearable devices, or any devices capable of receiving real-time video and sending betting information. The data may be presented in the form of, for example, rich site summary (RSS) feeds and push data. The video and/or data show one or more participants in a gambling activity. User devices 220 are used by one or more online users 230 to receive and view the video and to place bets. Online users 230 can be onsite at a real casino or can be at a remote location. For example, everything relevant and material to a gambling activity that is visible to a player at a real casino may be visible in real time to online users 230.

Server 210 also provides a betting interface. Server 210 displays the betting interface on one or more user devices 220, using the network. Server 210 receives at least one message from at least one user device 220. The at least one message represents a bet placed on a participant of the gambling activity by an online user. A bet can be placed on a number of different types of participants of the gambling activity in a number of different gambling environments.

### Online Over the Shoulder Betting on Participants in a Real Casino

In various embodiments, systems and methods for providing online OTS betting allow a bet to be placed on participant's wager or derivative wager empowered by the participant's physical presence, in a real casino in real gambling environment 240. Video (and/or other data) is received from one or more video and/or data devices 241 of one or more participants in the gambling activity. Based on the video from one or more video and/or data devices 241, an online user 230 places a bet on the participant's wager or places a bet on a derivative wager empowered by the participant's physical presence at the gambling venue, using one or more user devices 220.

Online Over the Shoulder Betting with a Participant in a Real Casino

In various embodiments, systems and methods for providing online OTS betting allow a bet to be placed with a participant 252 in a real casino in real gambling environment 250. Video is received from one or more video devices 251 of one or more participants in the gambling activity. Based on the video from one or more video devices 251, an online user 230 places a bet with participant 252. In other words, an online user 230 directs the betting of participant 252 by communicating with participant 252 through server 210, user device 220 and a participant device (not shown). Participant 252 can be referred to as an avatar of online user 230.

### Online Over the Shoulder Betting on Participants in a Virtual Casino

In various embodiments, systems and methods for providing online OTS betting allow a bet to be placed on participants in virtual gambling environment 260. Video is received from one or more devices 261 of one or more participants in an online gambling activity. Video can also be received from device 262 of an online casino. The video can include, but is not limited to, video of the participants, video from the displays of the participants showing gambling activity, or video from the online casino. Based on the video from one or more devices 261, an online user 230 places a bet on a participant using one or more user devices 220.

### Online Over the Shoulder Derivative Wagers

In addition to betting on or with a participant's wager, systems and methods for providing online OTS betting allow a user to place a wide variety of derivative wagers. In various embodiments, derivative wagers can be placed based on additional information, including, but not limited to, information about the participants, the gambling activity, or the people involved in OTS betting. Information about the participants can include, but is not limited to, a participant's skill, a participant's popularity, a participant's current position in a game or tournament, or a participant's celebrity status. Information about the gambling activity can include, for example, the cards held by each participant in a card game. Information about the people involved in OTS betting can include, for example, the number of people placing OTS bets on each participant.

In various embodiments, OTS derivative wagers can be based on one or more combinations of the additional information available. For example, OTS betters may be able to see all the hidden cards of participants in a card game. Since there can be many more OTS betters than participants in the card game, a pari-mutuel betting system can be used to set the odds for each participant based on their cards and popularity with OTS betters. Additionally, however, the odds can be adjusted based on the skill of the participant, the celebrity of the participant, or the participant's position in the card game. An exemplary derivative wager, therefore, can include the pari-mutuel odds of a particular celebrity beating last year's world champion of poker in a celebrity poker game, if she is currently holding a full house and has only $500 left to bet.

### System for Enabling Online Users to Place Bets on a Participant

Returning to FIG. 2, system 200 enables online users to place bets on a participant in a gambling activity using a network, in accordance with various embodiments.

Server 210 sends video and/or data in real time to one or more user devices 220 of one or more online users 230 using a network. The video shows one or more participants 252 in a gambling activity.

Server 210 provides a betting interface that receives at least one message from at least one user device of the one or more user devices 220 using the network. The at least one message represents a bet placed on at least one participant of one or more participants 252 by at least one online user of the one or more online users 230.

In various alternative embodiments, one or more online users 230 are virtual players.

In various alternative embodiments, the at least one message represents a direction to a participant of one or more participants 252 to place a bet in the gambling activity.

In various alternative embodiments, the at least one message represents advice or commentary to a participant of one or more participants 252 about the gambling activity, or information about the participant.

In various alternative embodiments, one or more online users 230 are virtual players that can see all cards of one or more participants 252.

In various alternative embodiments, the betting interface enables one or more online users 230 to bet on a participant winning three or more hands in row in a black-jack game.

In various alternative embodiments, the betting interface enables one or more online users 230 to offer insurance against bluffs.

In various alternative embodiments, the betting interface enables one or more online users 230 to bet on females winning more than males, or males winning more than females.

In various alternative embodiments, the betting interface enables one or more online users 230 to bet on pure skill of poker players.

In various alternative embodiments, the betting interface enables one or more online users 230 to bet on celebrity Indian poker.

In various alternative embodiments, the betting interface enables one or more online users 230 to bet on derivative wagers such as paramutual betting on the outcome of poker hands.

In various alternative embodiments, the betting interface enables one or more online users 230 to occupy private rooms within a regulated casino to gamble on the outcome of wagering on same casino's public tables via an avatar.

In various alternative embodiments, the betting interface enables one or more online users 230 to engage in betting on several tables simultaneously, and derivative wagers that can be developed with more complicated odds.

In various alternative embodiments, the betting interface enables sharing of previous betting results between players above basic information a house of the gambling activity provides the players with.

### Method for Enabling Online Users to Place Bets on a Participant

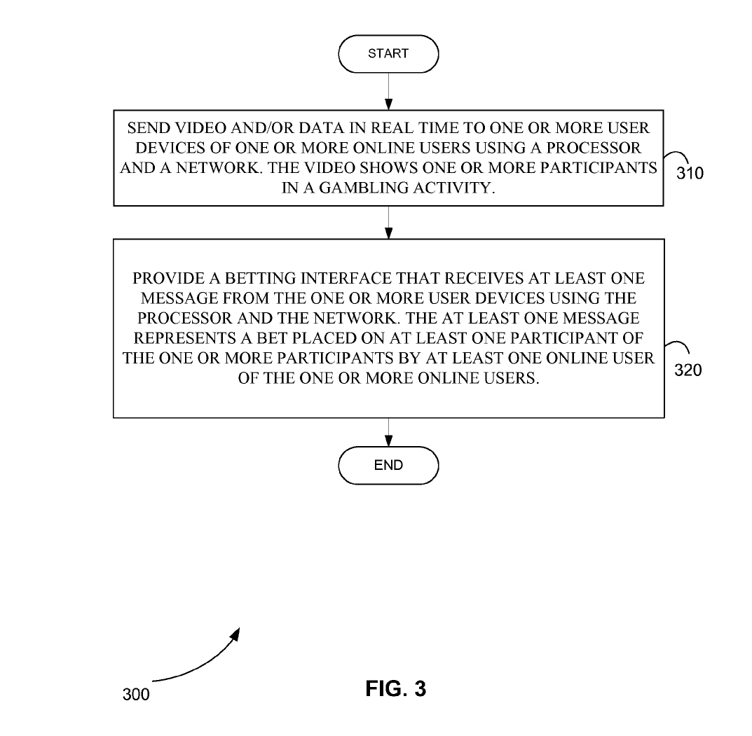

FIG. 3 is a flowchart showing a method 300 for enabling online users to place bets on a participant in a gambling activity using a network, in accordance with various embodiments.

In step 310 of method 300, video and/or data are sent in real time to one or more user devices of one or more online users using a processor and a network. The video shows one or more participants in a gambling activity.

In step 320, a betting interface that receives at least one message from the one or more user devices is provided using the processor and the network. The at least one message represents a bet placed on at least one participant of the one or more participants by at least one online user of the one or more online users.

### Computer Program Product for Enabling Online Users to Place Bets on a Participant

In various embodiments, computer program products include a tangible computer-readable storage medium whose contents include a program with instructions being executed on a processor so as to perform a method for enabling online users to place bets on a participant in a gambling activity using a network. This method is performed by a system that includes one or more distinct software modules.

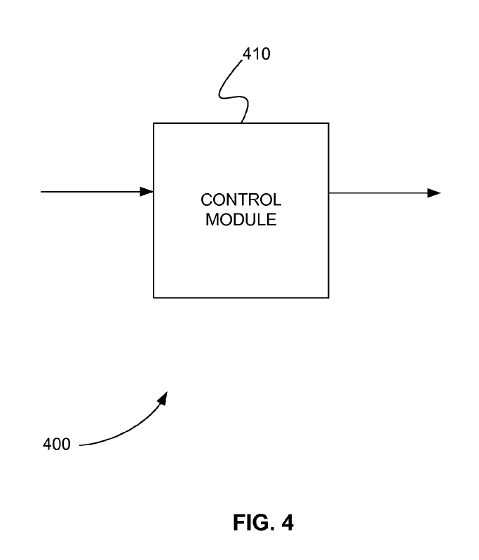

FIG. 4 is a schematic diagram of a system that includes one or more distinct software modules that performs a method for enabling online users to place bets on a participant in a gambling activity using a network, in accordance with various embodiments. System 400 includes control module 410.

Control module 410 sends video and/or data in real time to one or more user devices of one or more online users using a network. The video shows one or more participants in a gambling activity.

Control module provides a betting interface that receives at least one message from the one or more user devices using the network. The at least one message represents a bet placed on at least one participant of the one or more participants by at least one online user of the one or more online users.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

1. A system for enabling online users to place a derivative bet on a wager of a participant in a gambling activity using a network, comprising:
a server that
sends video and/or data in real time to one or more user devices of one or more online users using a network, the video showing one or more participants in a gambling activity; and
provides a betting interface that receives at least one message from at least one user device of the one or more user devices using the processor and the network, wherein the at least one message represents a derivative bet placed on at least one wager of at least one participant of the one or more participants by at least one online user of the one or more online users and wherein the odds of the derivative bet are based on the skill of the at least one participant, the celebrity of the at least one participant, or the at least one participant's position in the gambling activity.

2. The system of claim 1, wherein the at least one participant is physically present in a real casino.

3. The system of claim 1, wherein the at least one participant is gambling in a virtual casino.

4. (canceled)

5. The system of claim 1, wherein the one or more online users can see all cards of the one or more participants.

6. The system of claim 1, wherein the betting interface enables the one or more online users to bet on two or more consecutive wagers of a participant in a black-jack game.

7. The system of claim 1, wherein the betting interface further enables the one or more online users to offer insurance against bluffs.

8. The system of claim 1, wherein the betting interface enables the one or more online users to bet on wagers of females winning more than wagers of males, or wagers of males winning more than wagers of females.

9. (canceled)

10. The system of claim 1, wherein the gambling activity comprises celebrity Indian poker.

11. The system of claim 1, wherein the betting interface enables the one or more online users to bet on derivative wagers such as paramutual betting on the outcome of poker hands.

12. The system of claim 1, wherein the betting interface enables the one or more online users to occupy private rooms within a regulated casino to gamble on the outcome of wagering on same casino's public tables.

13. The system of claim 1, wherein the betting interface enables the one or more online users to engage in betting on wagers placed at several tables simultaneously.

14. (canceled)

15. A method for enabling online users to place a derivative bet on a wager of a participant in a gambling activity using a network, the method being implemented by a computer including a processor, the method comprising:
sending video and/or data in real time to one or more user devices of one or more online users using the processor and a network, the video showing one or more participants in a gambling activity; and
providing a betting interface that receives at least one message from the one or more user devices using the network, wherein the at least one message represents a derivative bet placed on at least one wager of at least one participant of the one or more participants by at least one online user of the one or more online users, wherein odds of the derivative bet are based on the skill of the at least one participant, the celebrity of the at least one participant, or the at least one participant's position in the gambling activity.

16. The method of claim 15, wherein the at least one participant is physically present in a real casino.

17. The method of claim 15, wherein the at least one participant is gambling in a virtual casino.

18. The method of claim 15, wherein the one or more online users can see all cards of the one or more participants.

19. The method of claim 15, wherein the betting interface enables the one or more online users to bet on two or more consecutive wagers of a participant in a black-jack game.

20. A computer program product, comprising a non-transitory and tangible computer-readable storage medium whose contents include a program with instructions being executed on a processor so as to perform a method for enabling online users to place a derivative bet on a wager of a participant in a gambling activity using a network, comprising:
providing a system, wherein the system comprises one or more distinct software modules, and wherein the distinct software modules comprise a control module;
sending video and/or data in real time to one or more user devices of one or more online users using the control module and a network, the video showing one or more participants in a gambling activity; and
providing a betting interface that receives at least one message from the one or more user devices using the control module and the network, wherein the at least one message represents a derivative bet placed on at least one wager of at least one participant of the one or more participants by at least one online user of the one or more online users, wherein odds of the derivative bet are based on the skill of the at least one participant, the celebrity of the at least one participant, or the at least one participant's position in the gambling activity.

21. The computer program product of claim 20, wherein the at least one participant is physically present in a real casino.

22. The computer program product of claim 20, wherein the at least one participant is gambling in a virtual casino.

23. The computer program product of claim 20, wherein the betting interface enables the one or more online users to bet on two or more consecutive wagers of a participant in a black-jack game.
